(19) United States
(12) Patent Application Publication
(10) Pub. No.: US 2008/0131172 A1
(43) Pub. Date: Jun. 5, 2008

(54) Non-magnetic monocomponent toner for use in electrophotographic image formation employing non-contact developing method, developing device, and image forming apparatus

(75) Inventor: Toru Takatsuna, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/998,390

(22) Filed: Nov. 29, 2007

(30) Foreign Application Priority Data
Nov. 30, 2006 (JP) 2006-324341

(51) Int. Cl. G03G 15/08; G03C 1/00

(52) U.S. Cl. 399/281; 430/57.5

(57) ABSTRACT

A non-magnetic monocomponent toner is provided for use in a developing device of a non-contact developing method, and is obtained by externally adding an external additive to cylindrical toner particles having a ratio of a cylindrical length (L) to a cylindrical diameter (D), (L/D), within a range from 1 to 2. The non-magnetic monocomponent toner having excellent developability for use in an electrophotograhic apparatus employing a non-contact developing method.

### BACKGROUND OF THE INVENTION

1. Field of the Invention

The present invention relates to a non-magnetic monocomponent toner for use in an electrophotographic image forming apparatus employing a non-contact developing method.

2. Description of the Related Art

A method for developing an electrostatic latent image on an latent image supporting member such as a photoconductor drum in an electrophotographic image forming apparatus includes a two-component developing method using a two-component developer containing a toner and a carrier, and a monocomponent developing method using only a toner.

The two-component developing method is excellent in characteristics such as transferrability, fixability and environment-resistant characteristics. However, in the two-component developing method, there is a problem that a toner density sensor for controlling a mixing ratio of the toner to the carrier is required and also a stirring mechanism of a developer is required, and thus the size of a developing device increases.

In contrast, the monocomponent developing method has such an advantage that a small-sized developing device can be used because the toner density sensor is not required.

The monocomponent developing method is classified into a magnetic monocomponent developing method using a magnetic monocomponent toner containing magnetic particles, and a non-magnetic monocomponent developing method using a non-magnetic monocomponent toner containing no magnetic particles. The non-magnetic monocomponent toner is excellent in fixability onto a paper as compared with the magnetic monocomponent toner. Therefore, a small-sized printer using the non-magnetic monocomponent developing method has widely been put into practice recently.

Such a non-magnetic monocomponent developing method is further classified into a contact developing method and a non-contact developing method. The contact developing method is a method in which development is performed by bringing a toner supporting member supporting the non-magnetic monocomponent toner into contact with an latent image supporting member. In contrast, the non-contact developing method is a method in which development is performed by providing a predetermined gap between a toner supporting member and an latent image supporting member and allowing the non-magnetic monocomponent toner to flow toward the latent image supporting member from the toner supporting member.

In the contact developing method, by bringing the non-magnetic monocomponent toner on the toner supporting member directly into contact with the latent image supporting member, a sufficient amount of the toner is supplied to the latent image supporting member, and thus high image density is obtained. However, in the contact developing method, a high mechanical load is applied to the non-magnetic monocomponent toner by contact friction between the non-magnetic monocomponent toner and the latent image supporting member. Also, there is a problem that the mechanical load causes a phenomenon such as filming in which the toner fuses and is left on the latent image supporting member, resulting in poor developability.

In contrast, in the non-contact developing method, since the toner supporting member is not directly brought into contact with the image supporting member, a high mechanical load is not applied to the non-magnetic monocomponent toner. However, there is a problem that since the toner supporting member is not directly brought into contact with the latent image supporting member, the amount of the non-magnetic monocomponent toner to be supplied to the latent image supporting member from the toner supporting member commonly decreases as compared with the contact developing method, and thus sufficient image density cannot be obtained.

As a method of improving developability in the non-contact developing method, the following method is known.

For example, Japanese Unexamined Patent Publication (Kokai) No. 6-118693 discloses a method in which the amount of friction electrostatic charge is decreased by retaining antimony-containing tin oxide in a non-magnetic toner in a free state, thereby increasing image density. According to this method, there arises a problem that, since antimony-containing tin oxide has remarkably low resistance, the charge amount of the toner particularly decreases in a high-temperature and a high-humidity atmosphere and thus image defects such as fog are likely to occur.

Also, Japanese Unexamined Patent Publication (Kokai) No. 9-43895 discloses a method in which an AC bias is used as a developing bias and fine particles having the same polarity and fine particles having reverse polarity are externally added to a toner. However, according to this method, when printing is continuously performed, embedding of the external additive may occur due to a mechanical load applied by contact between the toner in a developing device and a layer thickness regulating member. In this case, there arises a problem that a stable image cannot be obtained by decreasing the effect of the external additive.

Also, as a common method for producing a toner, a so-called grinding method of adding a colorant, a charge control agent and a releasant to a thermoplastic resin, followed by mixing, kneading, grinding and further classification is used. However, there is a problem that the toner surface of a ground toner obtained by a grinding method is a crushed surface, causing a low melting point component such as wax to be easily exposed on the toner surface, and thus causing a phenomenon such as filming in which the toner is fused onto an latent image supporting member in the form of a film. Also, when a thermoplastic resin having a high melting point, a high strength or a high hardness is used so as to suppress filming, there arises a problem that it becomes difficult to grind the toner, resulting in low productivity.

### SUMMARY OF THE INVENTION

An object of the present invention is to provide a non-magnetic monocomponent toner having excellent developability for use in an electrophotograhic apparatus using a non-contact developing method.

One aspect of the present invention pertains to a non-magnetic monocomponent toner for use in a developing device of a non-contact developing method, which is obtained by externally adding an external additive to cylindrical toner particles having a ratio of a cylindrical length (L) to a cylindrical diameter (D), (L/D), within a range from 1 to 2.

Also, the cylindrical toner particles preferably have a bending strength within a range from 9.8 to 196.1 MPa.

Objects, features, aspects and advantages of the present invention become more apparent from the following detailed description and accompanying drawings.

### BRIEF DESCRIPTION OF THE DRAWINGS

FIG. 1 is a schematic view showing a constitution of an image forming apparatus in which an image is formed using a non-magnetic monocomponent toner according to one embodiment of the present invention.

FIG. 2 is a schematic view showing a constitution of a non-magnetic monocomponent toner according to one embodiment of the present invention.

FIG. 3 is a schematic explanatory diagram for explaining a kneading step and fiberizing step in the production of cylindrical toner particles contained in a non-magnetic monocomponent toner according to one embodiment of the present invention.

FIG. 4 is a schematic explanatory diagram for explaining a cutting step in the production of cylindrical toner particles.

FIG. 5 is a schematic explanatory diagram for explaining a cylindrical toner particle.

### DETAILED DESCRIPTION OF THE INVENTION

Embodiments of the present invention will now be described in detail with reference to the accompanying drawings. The present invention is not limited to these embodiments.

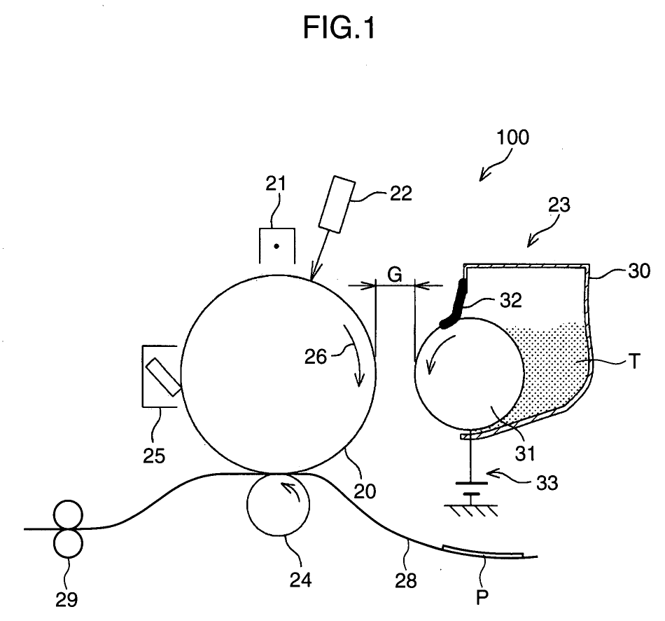

FIG. 1 is a schematic view showing a constitution of an image forming apparatus 100 in which an image is formed using a non-magnetic monocomponent toner according to one embodiment of the present invention.

Referring to FIG. 1, the image forming apparatus 100 includes a cylindrical latent image supporting member 20, a charger 21 for charging the latent image supporting member 20, an exposure device 22 for exposing the surface of the latent image supporting member 20 charged with the charger 21 corresponding to image data, a developing device 23 for supplying a non-magnetic monocomponent toner T to the latent image supporting member 20 on which an electrostatic latent image is formed by exposure, a transfer device 24 for transferring a toner image formed on the surface of the latent image supporting member 20 onto a paper P, and a removing device 25 for removing the toner left on the surface of the latent image supporting member 20 after transferring the toner image onto the paper P. The charger 21, the exposure device 22, the developing device 23, the transfer device 24 and the removing device 25 are sequentially arranged along a rotation direction (a direction indicated by arrow 26) of the latent image supporting member 20.

The developing device 23 includes a casing 30 which encases the non-magnetic monocomponent toner T, a cylindrical toner supporting member 31 which is disposed in the casing 30 and is capable of supporting a toner layer on a peripheral surface, and a regulating blade 32 which is a layer thickness regulating member which regulates the thickness of the toner layer supported on the peripheral surface of the toner supporting member 31 and charges the toner. This developing device 23 is a device for forming a toner image using a non-contact developing method, and a toner supporting member 31 and an latent image supporting member 20 are disposed in a state of facing each other while maintaining a predetermined gap G, a portion of the toner supporting member 31 facing the latent image supporting member 20 being exposed.

As the restricting blade 32, for example, a rubber blade made of a silicone rubber or a urethane rubber, a metallic blade made of stainless steel, or a glass blade is used. As the material of the toner supporting member 31, for example, a chloroprene rubber, an isoprene rubber, an EPDM rubber, a polyurethane rubber, an epoxy rubber, a butyl rubber and a silicone rubber are used.

The toner layer is formed by rotating the toner supporting member 31 (a direction indicated by arrow) and supporting electrostatically the non-magnetic monocomponent toner T. The thickness of the toner layer is adjusted to a roughly constant thickness that is smaller than the cavity gap G by the restricting blade 32 while rotating the toner supporting member 31.

On the surface of the toner supporting member 31, a toner layer made of the non-magnetic monocomponent toner T is supported. By applying a developing bias to the toner supporting member 31 on which the toner layer is supported, the non-magnetic monocomponent toner T flies toward the latent image supporting member 20 from the surface of the rotating toner supporting member 31, and adheres onto a peripheral surface of the latent image supporting member 20. In such a manner, the electrostatic latent image supported on the latent image supporting member 20 is developed with the non-magnetic monocomponent toner T.

The resulting toner image is transferred on a paper P conveyed by a conveyed device 28 by the transfer device 24. The toner image on the paper is conveyed to a fixing device 29 and fixed thereby. The toner T retaining on the surface of the latent image supporting member 20 after transferring the toner image is scraped off by the removing device 25.

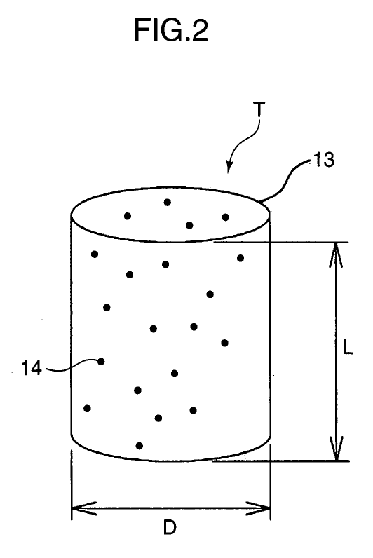

The non-magnetic monocomponent toner of the present embodiment will now be described with reference to FIG. 2.

The non-magnetic monocomponent toner of the present embodiment is a non-magnetic monocomponent toner which is obtained by externally adding an external additive 14 to cylindrical toner particles 13 having a ratio of a cylindrical length (L) to a cylindrical diameter (D), (L/D), within a range from 1 to 2.

As described in detail in Japanese Unexamined Patent Publication (Kokai) No. 2006-106236, the cylindrical toner particles 13 are obtained by melt-kneading a toner material, forming a toner material into a fiber, and cutting the fiber made of the toner material.

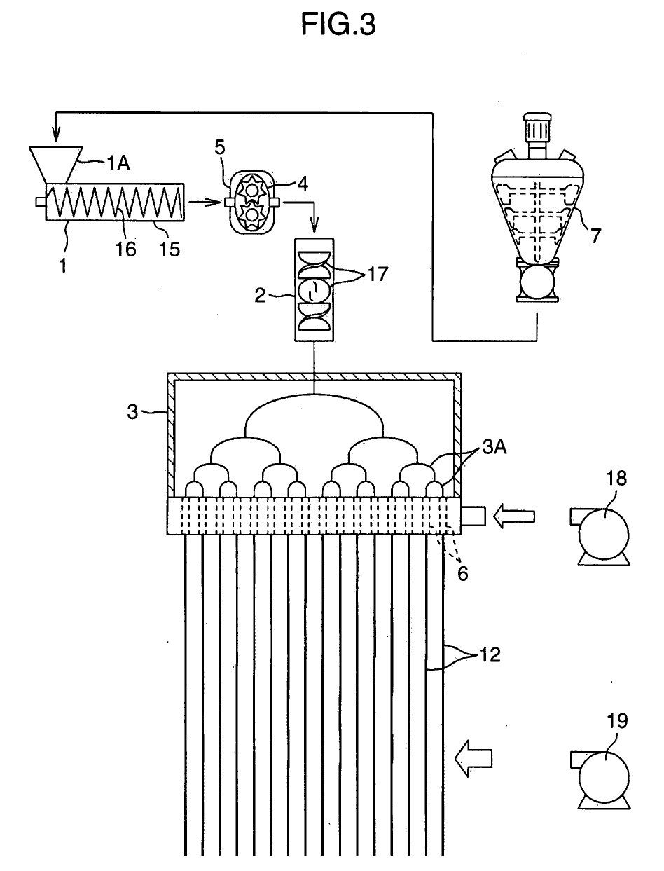

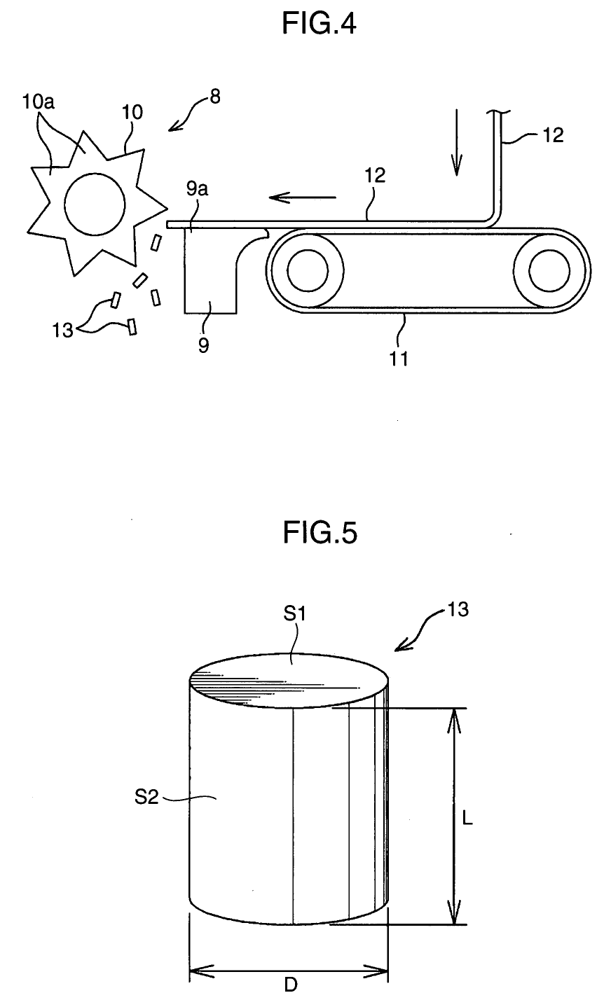

A method for producing the cylindrical toner particles will now be described in detail with reference to FIG. 3 and FIG. 4.

First, as shown in FIG. 3, a toner material is melt-kneaded in an extruder 1.

The toner material contains a binder resin, a colorant, a charge control agent and a releasant, which are as described hereinafter. These respective components are supplied to a premixing device (for example, Cyclomix manufactured by Hosokawa Micron Corporation) 7 and, after premixing, the premix is supplied to the extruder 1 through a hopper 1A. The extruder 1 is equipped with a cylinder 15 with a heater, and is also equipped with a rotary screw 16 for kneading the toner material in the cylinder 15. The respective components supplied to the extruder 1 are kneaded at a predetermined kneading temperature (for example, 140° C.) using the rotary screw 16. The extruder 1 is equipped with a gear pump 4 for adjusting the discharge amount of the molten toner material, driven by a motor 5, at a discharge port. The molten toner material is transferred to a static mixer 2 connected to the gear pump 4.

In the static mixer 2, multiple blades 17 composed of a twisted curved surface are disposed and a spiral flow passage is formed by the blades 17. The molten toner material transferred from the extruder 1 is further kneaded by rotation of the blades 17 and the respective components constituting the toner material are dispersed uniformly and finely. In the static mixer 2, the molten toner material is maintained at a temperature which is higher than the kneading temperature of the extruder (for example, 180° C.).

To the static mixer 2, a flow passage structure 3 including a multi-stage distributed flow passage 3A is connected. The molten toner material is supplied to the distributed flow passage 3A from the static mixer 2, heated to a higher temperature (for example, 215° C.) by a heater (not shown) disposed in the flow passage structure 3, and then extruded into a fiber through nozzles 6 provided at flow passage outlets of the respective distributed flow passages 3A. For example, the inner diameter of the discharge ports of the nozzles 6 is set to 5 μm.

The fiber-like molten toner material extruded through the nozzles 6 is drawn by hot air at about 215° C. blown from a hot air blowing device 18 and then quickly cooled by cold air blown from a cold air blowing device 19 to form a fiber-like toner 12.

A cutting step of cutting the fiber-like toner 12 thus formed will now be described.

As shown in FIG. 4, the fiber-like toner 12 thus formed is conveyed to a cutting device 8 as is using a conveying device 11. The cutting device 8 is equipped with a stationary knife 9 extending in a direction intersecting perpendicularly to a conveying direction of the fiber-like toner 12 to be conveyed on the conveying device 11, and a rotary knife 10 which is rotation-driven by a motor (not shown). The fiber-like toner 12 is continuously supplied between the stationary knife 9 and the rotary knife 10. Then, the fiber-like toner 12 is sequentially cut by a shear action produced between an edge 9a of the stationary knife 9 and a cutter blade 10a of the rotary knife 10 to continuously produce cylindrical toner particles 13.

The length L of the cylindrical toner particles 13 can be adjusted by the ratio of the conveying speed of the fiber-like toner 12 to the rotary speed of the rotary knife 10. Also, the diameter D of the cylindrical toner particles 13 can be adjusted by the inner diameter of the discharge ports of the nozzles 6.

In such a manner, cylindrical toner particle 13 having the length L (μm) and the cross-sectional diameter D (μm) as shown in FIG. 5 is obtained.

The diameter D of the cylindrical toner particle 13 is preferably within a range from 5 to 10 μm because the resulting non-magnetic monocomponent toner easily flies toward the latent image supporting member 20. L/D of the cylindrical toner particles 13 is within a range from 1 to 2. When L/D is within the above range, it is possible to suppress adhesion of the cylindrical toner particles 13 onto the toner supporting member 31, and thus the non-magnetic monocomponent toner satisfactorily flies toward the latent image supporting member 20 from the toner supporting member 31 upon development. Therefore, developability upon development is improved and a sufficient image density is obtained.

When L/D is less than 1, the proportion of a cut surface Si based on the entire external surface of cylindrical toner particle increases. Since a comparatively large amount of the wax is exposed on the cut surface and the surface is distorted, the contact area with the toner supporting member 31 increases and it becomes impossible to allow the toner to easily fly toward the latent image supporting member 20. When L/D is more than 2, the contact area between an external circumferential surface S2 of the cylindrical toner particles 13 and the toner supporting member 31 increases and thus it becomes impossible to allow the toner to easily fly toward the latent image supporting member 20.

L/D can be easily adjusted by adjusting the diameter of the discharge port of the nozzles 6 or adjusting the conveying speed of the fiber-like toner 12 and the rotary speed of the rotary knife 10.

In the non-magnetic monocomponent toner of the present embodiment, the bending strength of the cylindrical toner particles 13 is within a range from 9.8 to 196.1 MPa. In such a case, embedding of the external additive into the cylindrical toner particles 13 is suppressed. Consequently, a stable image density is maintained for a long period. The bending strength of the cylindrical toner particles is obtained by the following procedure. Namely, the cylindrical toner particles are melted, charged in a plate-shaped mold measuring 100 mm in thickness, 10 mm in width and 4 mm in thickness and then compression-molded to obtain a sample plate. Then, the sample plate is subjected to a bending test at a bending speed of 2 mm/min in conformity with the measuring conditions defined in JIS-K-7203 and the bending strength is measured.

In the case where the bending strength is less than 9.8 MPa, the external additive is embedded in the cylindrical toner particle 13 when printing is continuously performed and a high mechanical load is applied on the non-magnetic monocomponent toner, and thus it becomes impossible to sufficiently exert the effect of the external additive, resulting in decreased image density. In the case where the bending strength exceeds 196.1 MPa, the toner supporting member 31 is damaged by the non-magnetic monocomponent toner when printing is continuously performed, and thus it becomes difficult to form a stable toner layer (thin layer) on a peripheral surface of the toner supporting member 31, resulting in fog involved in poor charge and decreased image density.

A non-magnetic monocomponent toner is obtained by externally adding the external additive to the cylindrical toner particles produced by the procedure described above using a Henschel mixer (manufactured by Mitsui Mining Co., Ltd.).

The external additive is a component to be added so as to improve fluidity of the non-magnetic monocomponent toner. It is possible to use conventionally known external additives, for example, silica, alumina, tin oxide, titanium oxide, strontium oxide and various resin powders, each having a particle size within a range from several tens of nanometers to about several hundreds of nanometers, without any restriction.

The amount of the external additive to be added is preferably from 0.1 to 5 parts by mass, and more preferably from 0.5 to 3 parts by mass, based on 100 parts by mass of the cylindrical toner particles When the amount of the external additive is too small, fluidity decreases, and thus developability may deteriorate and image density (ID) may decrease. In contrast, when the amount of the external additive is too large, a thin layer of the toner to be formed on the surface of the toner supporting member becomes unstable and thus fog density (FD) may increase.

Constituent components of the toner material will now be described in detail.

It is possible to use, as the binder resin constituting the toner material, those which have conventionally been used as a binder resin for a toner without any restriction. For example, thermoplastic resins such as a polystyrene-based resin, a polyester-based resin, an acrylic-based resin, a styrene-acrylic-based copolymer, a polyethylene-based resin, a polypropylene-based resin, a vinyl chloride-based resin, a polyamide-based resin, a polyurethane-based resin, a polyvinyl alcohol-based resin, a vinylether-based resin, a N-vinyl-based resin and a styrene-butadiene-based resin are preferably used.

The polystyrene-based resin includes, in addition to a styrene homopolymer, a copolymer of styrene and a monomer which is copolymerizable with styrene. Examples of the monomer which is copolymerizable with styrene include p-chlorostyrene; vinyl naphthalene; ethylene unsaturated monoolefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butyrate; (meth) acrylate esters such as methyl acrylate, ethyl acrylate, n-butyl acrylate, isobutyl acrylate, dodecyl acrylate, n-octyl acrylate, 2-chloroethyl acrylate, phenyl acrylate, a-chloromethyl acrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinyl pyrrole, N-vinylcarbazole, N-vinylindole and N-vinyl pyrrolidene. These monomers may be used alone, or two or more kinds of them may be used in combination.

With respect to the molecular weight of the polystyrene-based resin used as the binder resin, it is preferred that the molecular weight distribution has at least two peaks, a peak of comparatively low molecular weight within a range from 3,000 to 20,000 and a peak of comparatively high molecular weight within a range from 300,000 to 1,500,000 and Mw/Mn (mass average molecular weight/number average molecular weight) is 10 or more. If the molecular weight distribution of the polystyrene-based resin is within the above range, a non-magnetic monocomponent toner having excellent fixability and anti-offset properties is obtained. The molecular weight can be determined by GPC (Gel Permeation Chromatography). For example, the molecular weight distribution can be determined from a calibration curve which is preliminarily obtained using a standard polystyrene resin after measuring the time of elution from a column by a molecular weight measuring device HLC-8220 manufactured by Tosoh Corporation using THF (tetrahydrofuran) as a solvent.

As the polyester-based resin, for example, those obtained by polycondensation of an alcohol component and a carboxylic acid component are used.

As specific examples of the alcohol component, dihydric alcohols include diols such as ethylene glycol, diethylene glycol, triethylene glycol, 1,2-propyleneglycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; such as bisphenols bisphenol A, hydrogenated bisphenol A, polyoxyethylenated bisphenol A and polyoxypropylenated bisphenol A; and tri- or higher polyhydric alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5,-trihydroxymethylbenzene.

As the carboxylic acid component, for example, a di-, tri- or higher polyhydric carboxylic acid, and an acid anhydride and a lower alkyl ester thereof are used. Specific examples of the dihydric carboxylic acid include maleic acid, fumaric acid, citraconic acid, itaconic acid, glutaconic acid, phthalic acid, isophthalid acid, terephthalic acid, cyclohexanedicarboxylic acid, succinic acid, adipic acid, sebacic acid, azelaic acid, malonic acid or an alkyl- or alkenylsuccinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid or isododecenylsuccinic acid. Specific examples of the tri or higher polyhydric carboxylic acid include 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and enpol trimer acid.

The softening point of the polyester-based resin is preferably from 110 to 150° C., and more preferably from 120 to 140° C., in view of excellent fixability.

The binder resin is preferably the above thermoplastic resin in view of good fixability. However, it is not required to use only the thermoplastic resin and a small amount of a crosslinked resin or thermosetting resin, whose gel fraction (the amount of a crosslinked moiety) is within a range from about 0.1 to 10% by mass, may be used. When a small amount of the crosslinked resin or the thermosetting resin having partially a crosslinked structure is used, storage stability and shape retention or durability of the toner can be improved without deteriorating fixability. The gel fraction can be measured using a Soxhlet extractor.

Specific examples of the thermosetting resin include epoxy-based resins such as a bisphenol A type epoxy resin, a hydrogenated bisphenol A type epoxy resin, a novolak type epoxy resin, a polyalkylene ether type epoxy resin and a cyclic aliphatic epoxy resin, and a cyanate-based resin. These thermosetting resins may be used alone, or two or more kinds of them may be used in combination.

The glass transition point (Tg) of the binder resin is preferably from about 50 to 70° C. When the glass transition point of the binder resin is lower than 50° C., the resulting toners may fuse to each other, thereby deteriorating storage stability. In contrast, when the glass transition point of the binder resin is higher than 70° C., fixability of the toner may become inferior. The glass transition point of the binder resin can be determined from the change point of the specific heat using a differential scanning calorimeter (DSC). For example, the glass transition point can be determined by the following procedure. Namely, 10 mg of a measuring sample is placed in an aluminum pan and measurement is performed at a measuring temperature within a range from 25 to 200° C. and a temperature raising rate of 10° C./min using a differential scanning calorimeter DSC-6200 manufactured by Seiko Instruments Inc. as a measuring device and using a vacant aluminum pan as a reference. The glass transition point can be determined from the change point of the resulting endothermic curve.

It is possible to use, as the releasant (wax) constituting the toner material, those which have conventionally been used as a releasant for a toner without any restriction. Specific examples thereof include vegetable waxes such as carnauba wax, sugarcane wax and Japan wax; animal waxes such as beeswax, insect wax, whale wax and wool wax; and synthetic hydrocarbon-based waxes such as Fischer-Tropsch (hereinafter referred sometimes as to “FT”) having an ester on the side chain, polyethylene wax and polypropylene wax.

Of these relesants, a FT wax having an ester on the side chain and a polyethylene wax are preferably used in view of excellent dispersibility.

The endothermic main peak in the endothermic curve measured by DSC of the releasant (wax) is preferably within a range from 70 to 120° C. When the endothermic main peak is lower than 70° C., a blocking phenomenon and a hot-offset phenomenon of the toner may occurs. In contrast, when the endothermic main peak is higher than 120° C., fixability at low temperature may not be obtained.

The amount of the releasant (wax) to be added is preferably within a range from 1 to 20 parts by mass based on 100 parts by mass of the binder resin. When the amount is less than 1 part by mass, the addition effect is less likely to be obtained. In contrast, when the amount is more than 20 parts by mass, blocking resistance deteriorates and also the releasant may fall from the toner.

Specific examples of the colorant constituting the toner material include black pigments, for example, carbon blacks such as acetylene black, lamp black and aniline black; yellow pigments such as Chrome Yellow, Zinc Yellow, Cadmium Yellow, Yellow Iron Oxide, Mineral Fast Yellow, Nickel Titanium Yellow, Nables Yellow, Naphthols Yellow S, Hansa Yellow G, Hansa Yellow 10G, Benzidine Yellow G, Benzidine Yellow GR, Quinoline Yellow Lake, Permanent Yellow NCG and Tartrazine Lake; orange pigments such as Chrome Orange, Molybdenum Orange, Permanent Orange GTR, Pyrazolone Orange, Vulcan Orange, Indathrene Brilliant Orange RK, Benzidine Orange G and Indathrene Brilliant Orange GK; red pigments such as Blood Red, Cadmium Red, Red Lead, Cadmium Mercury Sulfide, Permanent Red 4R, Lithol Red, Pyrazolone Red, Watching Red Calcium Salt, Lake Red D, Brilliant Carmine 6B, Eosine Lake, Rhodamine Lake B, Alizarin Lake and Brilliant Carmine 3B; violet pigments such as Manganese Violet, Fast Violet B and Methyl Violet Lake; blue pigments such as Prussian Blue, Cobalt Blue, Alkali Blue Lake, Bictoria Blue Lake, Phthalocyanine Blue, Metal-Free Phthalocyanine Blue, Partially Chlorinated Phthalocyanine Blue, Fast Skyblue and Indathrene Blue BC; green pigments such as Chromium Green, Chromium Oxide, Pigment Green B, Malachite Green Lake and Fanal Yellow Green G; white pigments such as zinc white, titanium oxide, antimony white and zinc sulfide, baryta powder, barium carbonate, clay, silica, white carbon, talc and alumina white.

The amount of the colorant to be added is preferably from 2 to 20 parts by mass, and more preferably from 3 to 15 parts by mass, based on 100 parts by mass of the binder resin.

It is possible to use, as the charge control agent constituting the toner material, those which have conventionally been used as a charge control agent for a toner without any restriction. Specific examples thereof include charge control agents which exhibit positive chargeability, for example, nigrosin, a quaternary ammonium salt compound and a resin type charge control agent obtained by bonding a resin with an amine-based compound. In the case of a color toner, a colorless or white charge control agent is preferred.

The amount of the charge control agent to be added is preferably from 0.5 to 10 parts by mass, and more preferably from 1 to 5 parts by mass, based on 100 parts by mass of the binder resin.

To the non-magnetic monocomponent toner, various additives such as a surface treating agent, which has conventionally been added to a toner, may be added.

### EXAMPLES

The present invention will now be described in more detail by way of examples. The present invention is not limited to these examples.

### Examples 1 to 3 and Comparative Examples 1 to 2

To a reaction vessel equipped with a condenser, which encases 200 parts by mass of toluene and 6 parts by mass of a polymerization initiator (2,2-azobis-2,4-dimethylvaleronitrile V-65 manufactured by Wako Pure Chemical Industries, Ltd.), a monomer mixture of 70 parts by mass of styrene and 30 parts by mass of butyl acrylate was added dropwise while maintaining the solution temperature at about 60 to 80° C. over 3 hours. The toluene was refluxed by the condenser. After the completion of dropwise addition, a polymerization reaction was performed for 12 hours while maintaining the solution temperature at 60° C. Then, the toluene was removed from the resulting resin solution by distillation under reduced pressure to obtain a binder resin composed of a styrene-butyl acrylate copolymer.

Using 100 parts by mass of the resulting binder resin, 4 parts by mass of a colorant (carbon black MA-100 manufactured by Mitsubishi Chemical Corporation), 2 parts by mass of a charge control agent (N-01 manufactured by Orient Chemical Industries, Ltd.) and 5 parts by mass of a releasant (wax: FT-100 manufactured by Nippon Seiro Co., Ltd) as a toner material, five kinds of cylindrical toner particles were produced by the above-mentioned production method using the apparatuses as shown in FIG. 3 and FIG. 4.

Any cylindrical diameter D of the resulting five kinds of cylindrical toner particles was about 5 μm, while the cylindrical length L was 4 μm, 5 μm, 7.5 μm, 10 μm and 12 μm, respectively. The cylindrical length L was adjusted by adjusting the rotary speed of the rotary knife 10 of the cutting device 8. At this time, L/D of the cylindrical toner particles was 0.8, 1, 1.5, 2 and 2.4, respectively.

L/D was determined by the following procedure. Namely, an image at 2,000 times magnification of the resulting cylindrical toner particles was taken under a scanning electron microscope (SEM). At this time, 100 cylindrical toner particles were extracted at random from the image and then the cylindrical length L and the cylindrical diameter D of the respective cylindrical toner particles were measured. Then, the averages of the cylindrical length L and of the cylindrical diameter D were determined. On the basis of the resulting averages, a value obtained by dividing the cylindrical length L of cylindrical toner particles by the cylindrical diameter D, L/D, was calculated. In the case where the cut surface does not intersect perpendicularly to the central axis of the cylindrical toner (in the case where the cut surface is inclined or curbed), the axis length of the central axis is referred to as the cylindrical length L.

The bending strength of the resulting cylindrical toner particles respectively was 49 MPa (500 kgf/cm²). The bending strength of the cylindrical toner particles was determined by the following procedure. Namely, a sample plate obtained by charging the resulting cylindrical toner particles respectively in a molten state in a plate-shaped mold measuring 100 mm in length, 10 mm in width and 4 mm in thickness and compression-molding was subjected to a bending test in conformity with the measuring conditions defined in JIS-K-7203. The bending test was performed at a bending speed of 2 mm/min.

### (Preparation of Non-Magnetic Monocomponent Toner)

To 100 parts by mass of the cylindrical toner particles thus obtained, 1.2 parts by mass of silica RA-200H (manufactured by Nippon Aerosil Co., Ltd.) as an external additive was added, followed by mixing using a Henschel mixer (manufactured by Mitsui Mining Co., Ltd.) to prepare five kinds of non-magnetic monocomponent toners as shown in Table 1.

### (Evaluation of Image Density)

The resulting non-magnetic monocomponent toner was respectively filled into a plain paper facsimile employing a non-contact developing method (a facsimile obtained by modifying a laser facsimile “LDC-790” manufactured by KYOCERA MITA Corporation so as to employ a non-contact developing method as the developing method) and an image was formed based on an original copy having an original copy density of 4% under a normal-temperature and a normal-humidity environment at a temperature of 20° C. and a humidity of 65%.

The image density (ID) was evaluated in the following manner. Using a reflection densitometer (TC-6D manufactured by Tokyo Denshoku Co., Ltd.), the image density (ID) was measured at three image formation portions per one formed image and the average of the resulting image density was determined.

The fog density (FD) was measured in the following manner. A image density of the blank portion in the above image forming paper was measured, and the average of the image density was determined. Then an average of an image density of a white paper was subtracted from the average of the image density of the blank portion to obtain a value (FD).

The image density (ID) and the fog density (FD) were evaluated at both the initiation of the image forming treatment (the initial stage) and after intermittent printing of 20,000 sheets. As used herein, intermittent printing means a printing mode in which printing of one sheet has been entirely completed and, after temporarily stopping driving, the subsequent printing operation starts. Since aging (non-printing drive) is performed before or after image formation, the driving time to the number of printed sheets further increases.

The case where the image density ID is 1.4 or above was rated “Excellent”, the case where the image density is 1.3 or more and less than 1.4 is rated “Good”, and the case where the image density is less than 1.3 is rated “Poor”. The case where FD is less than 0.002 is rated “Excellent”, the case where FD is 0.002 or more and 0.005 or less is rated “Good”, and the case where FD is more than 0.005 is rated “Poor”. The results are shown in Table 1.

TABLE 1

| | | | | Initial | | After printing 20,000 | |
|---|---|---|---|---|---|---|---|
| | Cylindrical | Cylindrical | | stage | | sheets | |
| | length (μm) | diameter (D) (μm) | L/D | ID | FD | ID | FD |
| Example 1 | 7.5 | 5 | 1.5 | 1.523 | 0.001 | 1.476 | 0.002 |
| Example 2 | 5 | 5 | 1.0 | 1.412 | 0.002 | 1.378 | 0.004 |
| Example 3 | 10 | 5 | 2.0 | 1.457 | 0.001 | 1.343 | 0.001 |
| Comparative | 4 | 5 | 0.8 | 1.372 | 0.003 | 1.189 | 0.009 |
| Example 1 | | | | | | | |
| Comparative | 12 | 5 | 2.4 | 1.390 | 0.001 | 1.120 | 0.002 |
| Example 2 | | | | | | | |

As is apparent from the results shown in Table 1, in the case of using non-magnetic monocomponent toners containing cylindrical toner particles whose L/D is within a range from 1 to 2 of Examples 1 to 3, both the image quality at the initial stage and that after intermittent printing of 20,000 sheets are good as compared with the case of using a non-magnetic monocomponent toner containing cylindrical toner particles whose L/D is 0.8 of Comparative Example 1 and a non-magnetic monocomponent toner containing cylindrical toner particles whose L/D is 2.4 of Comparative Example 2.

### Examples 4 to 7

In the same manner as in Example 1, except that the bending strength of cylindrical toner particles was adjusted to 7.9 MPa (80 kgf/cm²), 9.8 MPa (100 kgf/cm²), 196.1 MPa (2,000 kgf/cm²) and 225.4 MPa (2300 kgf/cm²), respectively, by adjusting molecular weight distribution through variation of the reaction time in the polymerization of the binder resin as shown in Table 2, non-magnetic monocomponent toners containing cylindrical toner particles having a cylindrical length (L) of 7.5 μm, a cylindrical diameter (D) of 5 μm and L/D of 1.5 were produced.

Then, each of the resulting non-magnetic monocomponent toners was filled into the same plain paper facsimile employing a non-contact developing method as in Example 1 and an image was formed based on an original copy having an original copy density of 0.2% under a normal-temperature and a normal-humidity environment at a temperature of 20° C. and a humidity of 65%, and then the image density was evaluated in the same manner as in Example 1. The results are shown in Table 2.

TABLE 2

| | | |
|---|---|---|
| | | After |
| | | printing |
| Bending | | 20,000 |
| strength | Initial stage | sheets |

| | (MPa) | ID | FD | ID | FD |
|---|---|---|---|---|---|
| Example 1 | 49.0 | 1.523 | 0.001 | 1.378 | 0.003 |
| Example 4 | 9.8 | 1.498 | 0.001 | 1.305 | 0.005 |
| Example 5 | 196.1 | 1.502 | 0.001 | 1.432 | 0.004 |
| Example 6 | 7.9 | 1.489 | 0.001 | 1.189 | 0.009 |
| Example 7 | 225.4 | 1.478 | 0.001 | 1.176 | 0.020 |

As is apparent from the results shown in Table 2, in the case of using non-magnetic monocomponent toners containing cylindrical toner particles having a bending strength within a range from 9.8 to 196.1 MPa of Examples 1, 4 and 5, both the image quality at the initial stage and that after intermittent printing of 20,000 sheets are good as compared with the case of using a non-magnetic monocomponent toner containing cylindrical toner particles having a bending strength of 7.9 MPa of Example 6 and a non-magnetic monocomponent toner containing cylindrical toner particles having a bending strength of 225.4 MPa of Example 7.

One aspect of the present invention described in detail pertains to a non-magnetic monocomponent toner for use in a developing device of a non-contact developing method, which is obtained by externally adding an external additive to cylindrical toner particles having a ratio of the cylindrical length (L) to the cylindrical diameter (D), (L/D), within a range from 1 to 2. When such a non-magnetic monocomponent toner is used for development of a non-contact developing method, the toner is less likely to adhere onto a member around a toner supporting member and easily flies toward an latent image supporting member. Therefore, developability upon development is improved and thus sufficient image density is obtained.

Also, the bending strength of the cylindrical toner particles is preferably within a range from 9.8 to 196.1 MPa. When the bending strength is within the above range, the toner supporting member is not damaged and also embedding of an external additive into cylindrical toner particles is suppressed, thus obtaining a stable image density for a long period.

The cylindrical diameter (D) of the cylindrical toner particles is preferably within a range from 5 to 10 μm because the resulting non-magnetic monocomponent toner easily flies toward the latent image supporting member.

The cylindrical toner particles are preferably obtained by cutting a fiber formed of a toner material in view of uniformity of the particle size.

The cylindrical toner particles preferably contain, as a binder resin, a polystyrene-based resin having molecular weight distribution which has at least two peaks, a peak within a range from 3,000 to 20,000 and a peak within a range from 300,000 to 1,500,000 and 10 or more of Mw/Mn (mass average molecular weight/number average molecular weight) because a non-magnetic monocomponent toner having excellent fixability and anti-offset properties is obtained.

The cylindrical toner particles preferably contain a binder resin having a glass transition point (Tg) within a range from 50 to 70° C. in view of excellent fixability and storage stability.

Another aspect of the present invention pertains to a developing device which is mounted in an image forming apparatus of a non-contact developing method, comprising a casing which encases the non-magnetic monocomponent toner, a cylindrical toner supporting member which is disposed in the casing and is capable of supporting a toner layer formed of the toner on a peripheral surface through rotation around a roller axis, and a layer thickness regulating member which is provided on a peripheral surface of the toner supporting member so as to contact with the toner supporting member, and regulates the thickness of the supported toner layer and charges the toner.

Still another aspect of the present invention pertains to an image forming apparatus of a non-contact developing method, comprising a cylindrical latent image supporting member, a charger for charging the latent image supporting member, an exposure device for exposing the surface of the latent image supporting member charged with the charger to form an electrostatic latent image, the developing device for forming a toner image by supplying a non-magnetic monocomponent toner to the latent image supporting member on which the electrostatic latent image is formed, a transfer device for transferring the toner image formed on the surface of the latent image supporting member onto a paper, and a removing device for removing the toner left on the surface of the latent image supporting member after transferring the toner image onto the paper being sequentially arranged along a rotation direction of the latent image supporting member, the developing device being arranged so that a peripheral surface of the toner supporting member and a peripheral surface of the latent image supporting member are disposed in a state of facing each other while maintaining a fixed gap.

This application is based on patent application No. 2006-324341 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A non-magnetic monocomponent toner for use in a developing device of a non-contact developing method, which is obtained by externally adding an external additive to cylindrical toner particles having a ratio of a cylindrical length (L) to a cylindrical diameter (D), (L/D), within a range from 1 to 2.

2. The non-magnetic monocomponent toner according to claim 1, wherein the cylindrical toner particles have a bending strength within a range from 9.8 to 196.1 MPa.

3. The non-magnetic monocomponent toner according to claim 1, wherein the cylindrical toner particles have a cylindrical diameter (D) within a range from 5 to 10 μm.

4. The non-magnetic monocomponent toner according to claim 1, wherein the cylindrical toner particles are obtained by cutting a fiber formed of a toner material.

5. The non-magnetic monocomponent toner according to claim 1, wherein the cylindrical toner particles contain, as a binder resin, a polystyrene-based resin having a molecular weight distribution which has at least two peaks, a peak within a range from 3,000 to 20,000 and a peak within a range from 300,000 to 1,500,000, and 10 or more of Mw/Mn (mass average molecular weight/number average molecular weight).

6. The non-magnetic monocomponent toner according to claim 1, wherein the cylindrical toner particles contain a binder resin having a glass transition point (Tg) within a range from 50 to 70° C.

7. A developing device which is mounted in an image forming apparatus of a non-contact developing method, comprising:
a casing which encases the non-magnetic monocomponent toner according to claim 1,
a cylindrical toner supporting member which is disposed in the casing and is capable of supporting a toner layer formed of the toner on a peripheral surface through rotation around a roller axis, and
a layer thickness regulating member which is provided on a peripheral surface of the toner supporting member so as to contact with the toner supporting member, and regulates the thickness of the supported toner layer and charges the toner.

8. An image forming apparatus of a non-contact developing method, comprising:
a cylindrical latent image supporting member, a charger for electrostatic charging the latent image supporting member, an exposure device for exposing the surface of the latent image supporting member charged with the charger to form an electrostatic latent image, the developing device according to claim 7 for forming a toner image by supplying the non-magnetic monocomponent toner to the latent image supporting member on which the electrostatic latent image is formed, a transfer device for transferring the toner image formed on the surface of the latent image supporting member onto a paper, and a removing device for removing the toner left on the surface of the latent image supporting member after transferring the toner image onto the paper being sequentially arranged along a rotation direction of the latent image supporting member, the developing device being arranged so that a peripheral surface of the toner supporting member and a peripheral surface of the latent image supporting member are disposed in a state of facing each other while maintaining a predetermined gap.
